(19) United States
(12) Patent Application Publication
(10) Pub. No.: US 2011/0081913 A1
(43) Pub. Date: Apr. 7, 2011

(54) METHOD OF BANDWIDTH EXTENSION BY AGGREGATING BACKWARDS COMPATIBLE AND NON-BACKWARDS COMPATIBLE CARRIERS

(76) Inventors: Jung A. Lee, Pittstown, NJ (US); Said Tatesh, Swindon (GB)

(21) Appl. No.: 12/751,752

(22) Filed: Mar. 31, 2010

Related U.S. Application Data
(60) Provisional application No. 61/278,206, filed on Oct. 2, 2009.

(51) Int. Cl. H04W 72/12

(52) U.S. Cl. 455/450

(57) ABSTRACT

Methods of component carrier aggregation are provided. One embodiment of the method includes aggregating, at a base station, one or more first component carriers that are backwards compatible with a first carrier type and one or more second component carriers that are non-backwards compatible with the first carrier type for communication with first user equipment according to a second carrier type used by the second component carrier(s).

### CROSS REFERENCE TO RELATED APPLICATIONS

This application claims priority to U.S. Provisional Patent Application 61/278,206 filed Oct. 2, 2009.

### BACKGROUND OF THE INVENTION

1. Field of the Invention

This invention relates generally to communication systems, and, more particularly, to wireless communication systems.

2. Description of the Related Art

Service providers typically provide wireless connectivity within a bandwidth that has been assigned or allocated to the service provider. In the fourth-generation (4G) wireless communication standard known as UMTS Long Term Evolution (LTE), service providers are assigned one or more component carriers (CC) for supporting wireless communication over the air interface. Each component carrier is centered on a particular frequency and has a predetermined bandwidth. For example, the bandwidth numerology of LTE specifies that the component carriers may have bandwidths of 1.4 MHz, 3 MHz, 5 MHz, 10 MHz, 15 MHz, and 20 MHz that support 6, 15, 25, 50, 75, and 100 physical resource blocks, respectively. Radiofrequency leakage requirements limit the usable bandwidth of the component carrier, e.g., to 4.5 MHz of a 5 MHz bandwidth. Fast Fourier transform (FFT) requirements limit the maximum bandwidth of a component carrier, e.g. a 2048 point FFT limits the maximum CC bandwidth to approximately 20 MHz in LTE Release 8. A guard band is also included between component carriers used by different service providers to reduce or mitigate interference between transmissions over the different component carriers.

The component carriers can support multiple subcarriers such as the subcarriers used in Orthogonal Frequency Division Multiplexing (OFDM). The subcarriers can be further subdivided into time intervals so that each component carrier is made up of multiple physical resource blocks defined by the subcarrier bandwidth and time interval. The physical resource blocks can then be allocated to various data and control channels. Component carriers typically include overhead channels that support wireless connectivity with idle and/or active mobile units. For example, component carriers can include overhead channels that provide system information, synchronization, and paging for cells in the wireless communication system. Component carriers also include overhead channels that enable synchronization, camping, access, and reliable control coverage in heterogeneous network environment. In Release 8 of LTE, each component carrier includes one or more physical downlink control channels (PDCCHs) for providing the overhead information for the downlink. One or more physical uplink control channels (PUCCH) can be used to provide the overhead information for the uplink.

Each successive generation of wireless communication system typically supports larger bandwidths for communication over the air interface. For example, a planned development of LTE known as LTE-Advanced may support combined bandwidths up to 100 MHz. Base stations and mobile units that operate according to LTE-Advanced may therefore communicate at much higher rates than base stations and mobile units that operate according to LTE, e.g., Release 8 of LTE.

### SUMMARY OF THE INVENTION

Despite the advantages of converting to LTE-Advanced, service providers and users typically upgrade from earlier generations in incremental fashion. Consequently, both the wireless communication infrastructure and the population of user equipment are likely to be a heterogeneous mixture of devices that operate according to the most recent technologies, such as LTE-Advanced, and legacy technologies such as LTE.

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for component carrier aggregation. One embodiment of the method includes aggregating, at a base station, one or more first component carriers that are backwards compatible with a first carrier type and one or more second component carriers that are non-backwards compatible with the first carrier type for communication with first user equipment according to a second carrier type used by the second component carrier(s).

In another embodiment, a method is provided for scheduling user equipment. One embodiment of the method includes scheduling, at a base station, first user equipment to a first component carrier that is backwards compatible with a first carrier type for communication according to the first carrier type and second user equipment to one or more second component carriers that are non-backwards compatible with the first carrier type during a first time interval. This embodiment of the method also includes scheduling the second user equipment to the first component carrier and the second component carrier during a second time interval.

In yet another embodiment, a method is provided for operating user equipment. Embodiments of the method include performing, at first user equipment, scheduled communication with a base station over a first component carrier that is backwards compatible with a first carrier type and one or more second component carriers that are non-backwards compatible with the first carrier type during a first time interval. This embodiment also includes performing, at the first user equipment, scheduled communication with the base station over the second component carriers during a second time interval concurrently with second user equipment performing scheduled communication with the base station over the first component carrier. The second user equipment is incompatible with a second carrier type of the second component carriers.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates one proposed component carrier structure;

FIGS. 2(a) and 2(b) conceptually illustrate first and second exemplary embodiments of a component carrier structure formed by aggregating a backward-compatible component carrier and one or more non-backwards-compatible component carriers;

FIGS. 3(a) and 3(b) conceptually illustrate alternate configurations of a third exemplary embodiment of a component carrier structure;

FIGS. 4(a) and 4(b) conceptually illustrate fourth and fifth exemplary embodiments of a component carrier structure;

FIGS. 5(a) and 5(b) conceptually illustrate sixth and seventh exemplary embodiments of a component carrier structure;

FIG. 6 conceptually illustrates scheduling of physical resource blocks (PRB) for an aggregated component carrier structure;

FIG. 7 conceptually illustrates scheduling of physical resource blocks (PRB) for an asymmetric aggregated component carrier structure;

FIGS. 8(a-d) conceptually illustrate exemplary embodiments of a component carrier structure; and

FIG. 9 conceptually illustrates one exemplary embodiment of a wireless communication system that implements carrier aggregation.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

At least in part because of the tendency for users to upgrade wireless communication equipment incrementally, service providers have a strong incentive to deploy or upgrade to infrastructure that can support wireless communication with user equipment that operate according to current and legacy technologies. Simply replacing the existing carriers with a wider bandwidth single carrier LTE-A would not be compatible with legacy deployments and would therefore exclude large numbers of subscribers from the upgraded system. Carrier extension segments could be used to preserve backwards-compatibility of LTE-Advanced component carriers to legacy user equipment while increasing the bandwidth available to user equipment that operate according to LTE-Advanced.

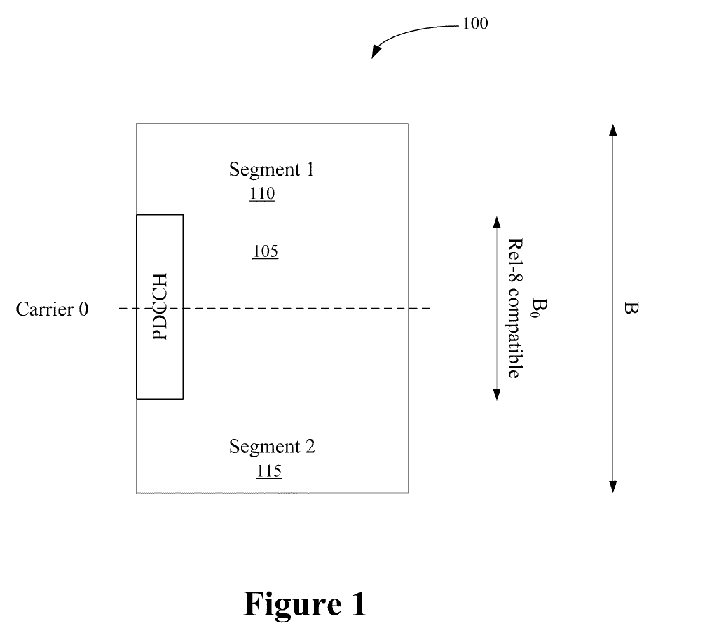

FIG. 1 conceptually illustrates one proposed component carrier structure 100 including a central component carrier 105 that is compatible with legacy Release 8 of LTE user equipment and extension segments 110, 115. The central component carrier 105 allocates physical resource blocks to the physical downlink control channel (PDCCH) and additional DL channels to provide system information, synchronization, camping and paging for cells in the wireless communication system. In one embodiment, the PDCCH is transmitted in the portion of the carrier that suffers the least interference to support reliable control coverage.

The extension segments 110, 115 can be used to increase the bandwidth available to LTE-Advanced user equipment. However, the extension segments 110, 115 are not backward compatible and so earlier generations of user equipment are restricted to using the central component carrier 105 and cannot take advantage of the increased bandwidth of the extension segments 110, 115. In the configuration depicted in FIG. 1, the LTE-Advanced carrier bandwidth is B MHz, where the central B₀ MHz is defined in the legacy system information, and for example Rel-8 user equipment would be aware of this part only. The extended carrier bandwidth of B MHz would be conveyed to the LTE-Advanced user equipment only. Therefore, the legacy user equipment would have a notion of B₀ MHz while LTE-A user equipment would have a notion of the extended B MHz. Within the central B₀ MHz all control and data structure support user equipment (UE) operation according to the legacy system specification, e.g., the Rel-8 specifications.

Using extension segments 110, 115 to increase the bandwidth has a number of limitations. For example, the PDCCH must remain in the central component carrier 105. Consequently, the extension segments 110, 115 do not support independent control channel functionality and cannot operate independently of the central component carrier 105. The extension segments 110, 115 therefore cannot provide system information, synchronization, and paging independently of the central component carrier 105. The extension segments 110, 115 also do not support independent synchronization, camping, and reliable control coverage in heterogeneous network environment. Consequently, the extension segments 110, 115 cannot be operated as stand-alone component carriers and must be a part of a component carrier set where at least one of the carriers in the set is a stand-alone-capable and backwards compatible component carrier. A carrier segment is defined as contiguous bandwidth extension of a backwards compatible component carrier. Given the above characteristics, extension carriers/carrier segments are not backwards compatible for Release 8 and Release 9 UEs. Another disadvantage to using extension segments 110, 115 is that the bandwidth expansion provided by the extension segments 110, 115 must be symmetric about the central component carrier 105. Furthermore, the maximum bandwidth available to the component carrier structure 100 is still limited by the FFT requirements and, in the case of LTE, the bandwidth of the component carrier structure 100 is limited to less than 20 MHz.

One alternative to using carrier extensions is to aggregate component carriers so that user equipment can be scheduled over the entire aggregated spectrum of the multiple carriers. In one embodiment that may be implemented in LTE-A, carrier aggregation can be adopted for bandwidth extension beyond the system bandwidths that are defined in LTE, e.g. the bandwidths of 1.4 MHz, 3 MHz, 5 MHz, 10 MHz, 15 MHz, and 20 MHz that are defined by the numerology of LTE and the FFT limitations of the legacy system. Carrier aggregation allows each base station (or other entity) to schedule multiple component carriers (CC) to each user equipment (UE) or mobile unit, thereby potentially enabling higher peak data rate to the UEs while allowing flexible spectrum usage for the operators. Embodiments of the techniques described herein may also provide spectrally efficient carrier deployments for the operators with multiple spectrum blocks, with varying timeframe for deployment.

Generally, embodiments of the techniques described herein support aggregation of component carriers that have different carrier types. The aggregated component carriers include one or more component carriers that are backwards compatible with previous or legacy carrier types so that these component carriers can support communication with previous or legacy generations of user equipment or mobile units. The aggregated component carriers also include one or more component carriers that are non-backwards compatible with previous or legacy carrier types. Legacy user equipment or mobile units may not be able to use the non-backwards compatible component carriers at least in part because the non-backwards compatible component carriers can use a different frequency numerology than the backwards compatible component carriers and cover a significantly larger frequency range.

As used herein, the phrase “backwards compatible component carrier” will be understood to refer to a component carrier that is accessible to user equipment of previous generations of standards and/or protocols that are used to implement the user equipment. For example, a backward-compatible component carrier may be a component carrier that is accessible to user equipment of all existing LTE releases. Backward-compatible component carriers provide system information, synchronization and paging to different generations of UEs, such as UEs that operate according to existing LTE releases like Release 8 and LTE-Advanced. Also, the backwards compatible carriers can enable synchronization, camping, access and reliable control coverage for different generations of UEs in heterogeneous network environments. A backward-compatible component carrier can be operated as a single stand-alone carrier or as one of a group of aggregated component carriers. Backward-compatible component carriers occur in uplink/downlink pairs in systems that implement frequency division duplexing (FDD).

As used herein, phrases such as “non-backwards compatible component carrier” or “backwards incompatible component carrier” will be understood to refer to a component carrier that is not accessible to UEs of earlier releases, but is accessible to UEs of the release defining the non-backwards compatible component carrier. Incompatibility between component carrier definitions can be caused by different bandwidth numerologies, different maximum bandwidth limits such as those imposed by FFT constraints, different FDD duplex distances that indicate the frequency separation between uplink and downlink channel pairs, and the like. For example, non-backward compatible carriers defined in LTE-A may not be accessible to LTE UEs and consequently the non-backward-compatible carriers do not support LTE UEs in idle or connected state. The non-backward compatible carriers support post-LTE-release (e.g. LTE-A) UEs and provide the new generation UEs with specific structure and functionalities. Non-backward-compatible component carriers can be operated as a single carrier (stand-alone) if the non-backwards compatibility originates from the duplex distance. Non-backwards compatible component carriers can also be used as a part of a carrier aggregation scheme. Provisioning non-backward compatible carriers have the potential to improve system performance by removing design constraints imposed by the backward compatibility issues such as the limitations imposed by the LTE bandwidth numerology, duplex distance, and maximum bandwidth limits imposed by FFT constraints.

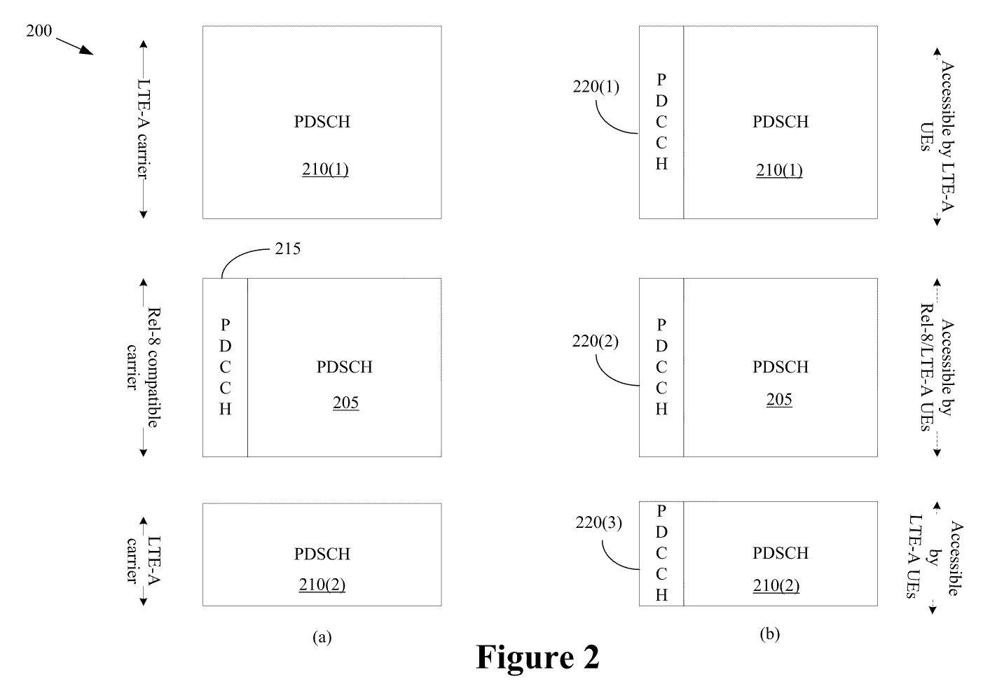

FIGS. 2(a) and 2(b) conceptually illustrate first and second exemplary embodiments of a component carrier structure 200 formed by aggregating a backward-compatible component carrier 205 and one or more non-backwards-compatible component carriers 210(1-2). The component carrier structure 200 is depicted in frequency-time space with the frequency of the allocated bandwidth increasing from bottom to top of the figure and with the allocated time interval increasing from left to right in the figure. Units of frequency and time are arbitrary. The illustrated component carrier structure 200 can be used for downlink (forward link) communication. In the first and second exemplary embodiments, the backward-compatible component carrier 205 is compatible with Release 8 of LTE and the non-backward compatible component carriers 210 operate according to a subsequent release such as LTE-Advanced. However, persons of ordinary skill in the art having benefit of the present disclosure should appreciate that other embodiments may utilize other standards and/or protocols, as well as different releases thereof.

The backward-compatible component carrier 205 and the non-backward-compatible component carriers 210 are not contiguous in frequency and are separated by gaps or guard bands in frequency. For example, different service providers may provide the backward-compatible carrier 205 and the non-backwards compatible carriers 210. The guard band may be used to provide interference mitigation between signals provided by the different service providers as well as for other purposes. The bandwidth of the gaps or guard bands is a matter of design choice. The bandwidth allocated to the carriers 205, 210 may differ in various embodiments. In the illustrated embodiment, the non-backwards compatible component carrier 210(1) has a larger bandwidth than the backward-compatible component carrier 205, while the non-backward-compatible component carrier 210(2) has a smaller bandwidth than the backward-compatible component carrier 205. However, persons of ordinary skill in the art having benefit of the present disclosure should appreciate that the particular bandwidth allocations depicted in FIGS. 2(a) and 2(b) are intended to be illustrative and not to limit the claimed subject matter.

The component carriers 205, 210 may support physical downlink control channels 215, 220 that are used to carry control information for the component carriers 205, 210. Exemplary control information carried by the PDCCH 215 may include synchronization signals, paging information, pilot signals, access information, and the like. The backward-compatible component carrier 205 and the non-backwards compatible component carriers 210 can therefore be scheduled independently or as an aggregated component carrier, as will be discussed herein. For example, Rel-8 UE operation is allowed in Rel-8 compatible carriers 205 and operation of UEs that support LTE-A is allowed in the Rel-8 compatible carrier 205 and/or the LTE-A carriers 210. For LTE-A UE, the physical downlink scheduling channel (PDSCH) may be transmitted in one or multiple carriers in a subframe. A carrier indicator field (CIF) in a new downlink control information (DCI) format for the downlink allocation indicates the component carrier for PDSCH transmission.

In the first exemplary embodiment shown in FIG. 2(a), control channels for both the backwards compatible component carrier 205 and the non-backwards compatible component carriers 210 are carried by channels in the backward-compatible component carrier 205. For example, resources of the backwards compatible carrier 205 can be allocated to a physical downlink control channel (PDCCH) 215 that can be configured to carry control information for both the backwards compatible carrier 205 and the non-backward-compatible carriers 210. Each UE therefore monitors three PDCCHs 215 in the backwards compatible carrier 205 to determine the downlink (DL) allocation. In some embodiments, additional channels associated with the extension carriers 210 may also be supported by resources of the backwards compatible carrier 205. For example, control signaling and/or overhead channels for the non-backwards compatible component carriers 210 (e.g., synchronization signals, primary broadcast signals, and wideband reference signals such as cell-specific reference signals for the aggregated first and second component carriers) may not be carried by the non-backwards compatible component carriers 210. Instead, they can be carried by physical resource blocks of the base backwards compatible carrier 205.

Allocating physical resource blocks in the backwards compatible carrier 205 to some or all of the control signaling channels for the non-backwards compatible component carriers 210 may increase the flexibility of the carrier aggregation scheme. Some wireless communication systems, standards, and/or protocols require that the particular signaling channels be transmitted substantially continuously or during particular time intervals.

Allocating resources in the backwards compatible carrier 205 to control signal channels for the non-backward-compatible carriers 210 can satisfy these requirements by providing these control signal channels to current and legacy user equipment over the backwards compatible carrier 205. The extension, non-backwards compatible component carriers 210 can therefore be supported in a flexible manner by the system operators while still satisfying the requirements of the system, standards, and/or protocols. For example, one or more of the extension carriers 210 can be turned off semi-statically under certain conditions, such as when the cell loading is below a selected threshold, to save network energy. This is a cell DTX mechanism for extension carriers. The extension carriers 210 can also be turned on when demand increases such that granting access to requesting user equipment would result in a cell load that is above the selected threshold. Operation of the legacy user equipment and/or the LTE-A user equipment is not affected by this capability since both types of user equipment can access the network by acquiring and camping on the stand-alone capable carrier 205.

In the second exemplary embodiment shown in FIG. 2(b), the backwards compatible component carrier 205 and the non-backwards compatible component carriers 210 each carry their respective control channels. For example, resources of the backwards compatible carrier 205 can be allocated to a physical downlink control channel (PDCCH) 220(2) that can be configured to carry control information for the backwards compatible carrier 205. Resources of the non-backwards compatible carriers 210 can be allocated to physical downlink control channels (PDCCH) 220(1, 3) that can be configured to carry control information for the non-backward-compatible carriers 210. When the component carriers 205, 210 are aggregated, each UE monitors the PDCCHs 220 in the three component carriers 205, 210 to determine the DL allocation.

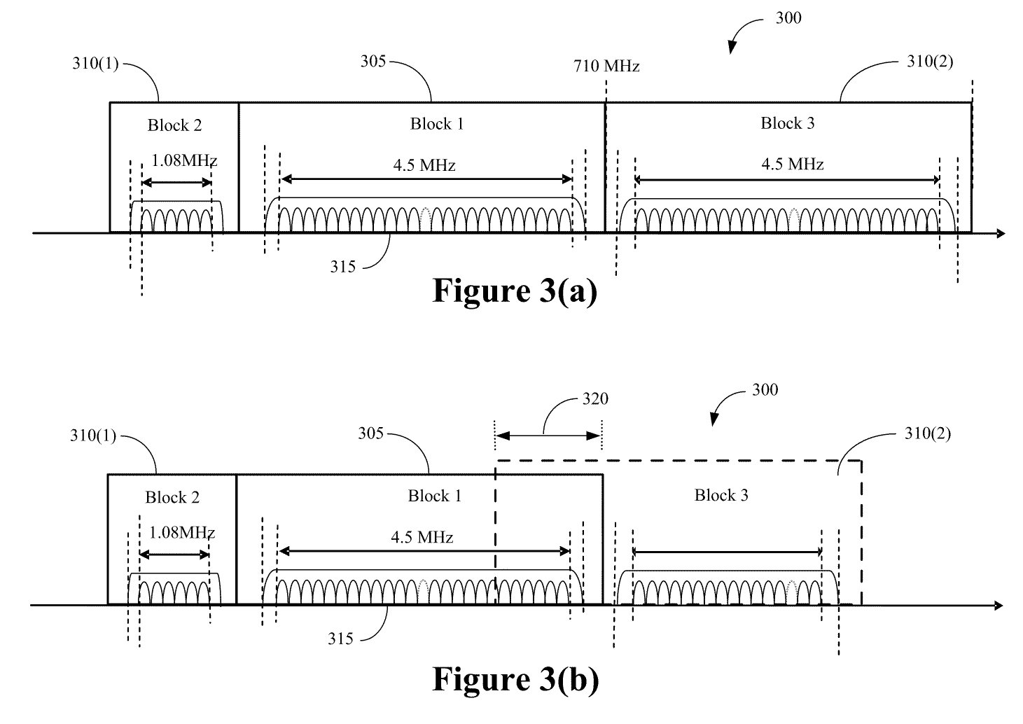

FIG. 3(a) conceptually illustrates a third exemplary embodiment of a component carrier structure 300 formed by aggregating a backward-compatible component carrier 305 and one or more non-backwards-compatible component carriers 310(1-2). The component carrier structure 300 is depicted in frequency space with the frequency of the allocated bandwidth increasing from left to right of the figure. The usable frequency space is shown as 1.08 MHZ for the component carrier 310(1) that has a full bandwidth of 1.4 MHz and 4.5 MHz for the component carriers 305, 310(2) that have full bandwidths of 5 MHz. Each component carrier 305, 310 supports multiple subcarriers 315 (only one indicated by a numeral in FIG. 3(a)). In the third exemplary embodiment, the backward-compatible component carrier 305 is compatible with Release 8 of LTE and the non-backward compatible component carriers 310 operate according to a subsequent release such as LTE-Advanced. However, persons of ordinary skill in the art having benefit of the present disclosure should appreciate that other embodiments may utilize other standards and/or protocols, as well as different releases thereof.

The component carriers 305, 310 shown in FIG. 3(a) are contiguous and utilize adjacent bandwidths with substantially no gaps between the allocated bandwidths. Since the component carriers 305, 310 are contiguous, aggregating the backward-compatible component carrier 305 with the non-backwards compatible component carrier 310 allows bandwidth-efficient access by allowing the operator to utilize the aggregated spectrum as one carrier, while supporting a mixture of LTE Rel-8 and LTE-A UEs in a cell. The aggregated bandwidth of the aggregated component carriers 305, 310 shown in FIG. 3(a) is approximately 11.4 MHz.

FIG. 3(b) depicts an alternative embodiment that may be employed in a communication system that supports a smaller total bandwidth capability. In the illustrated embodiment, a total aggregated bandwidth of approximately 10.4 MHz is available and the component carriers 305, 310 are deployed with an overlap region 320 between the backward-compatible component carrier 305 and the non-backward-compatible component carrier 310(2), which is depicted in FIG. 3(b) as a dashed box. The overlap region 320 is used to support physical resource blocks associated with the backward-compatible component carrier 305. In some embodiments, some or all of the control signaling and/or overhead channels for the non-backward-compatible component carrier 310 is supported by physical resource blocks in the backward-compatible component carrier 305. This may provide flexibility in determining the size of the overlap region 320 without contradicting existing standards and/or protocols that may require the presence of particular control signaling channels and/or overhead channels for the component carriers 305, 310.

Overlapping the carrier deployment between the backward compatible carrier and the extension carrier in this fashion may enable operators with spectrum bandwidth that is not supported by a particular release of the standards to fully utilize their available spectrum. For example, if an operator has an available spectrum bandwidth of 6 MHz but a legacy release of the standards only supports a 5 MHz component carrier bandwidth, then a base carrier having a 5 MHz bandwidth could be overlapped with a 3 MHz bandwidth extension carrier. Overlapping the base and extension carriers by 2 MHz (or more) would allow the overlapped carriers to fit within the operator's available bandwidth of 6 MHz.

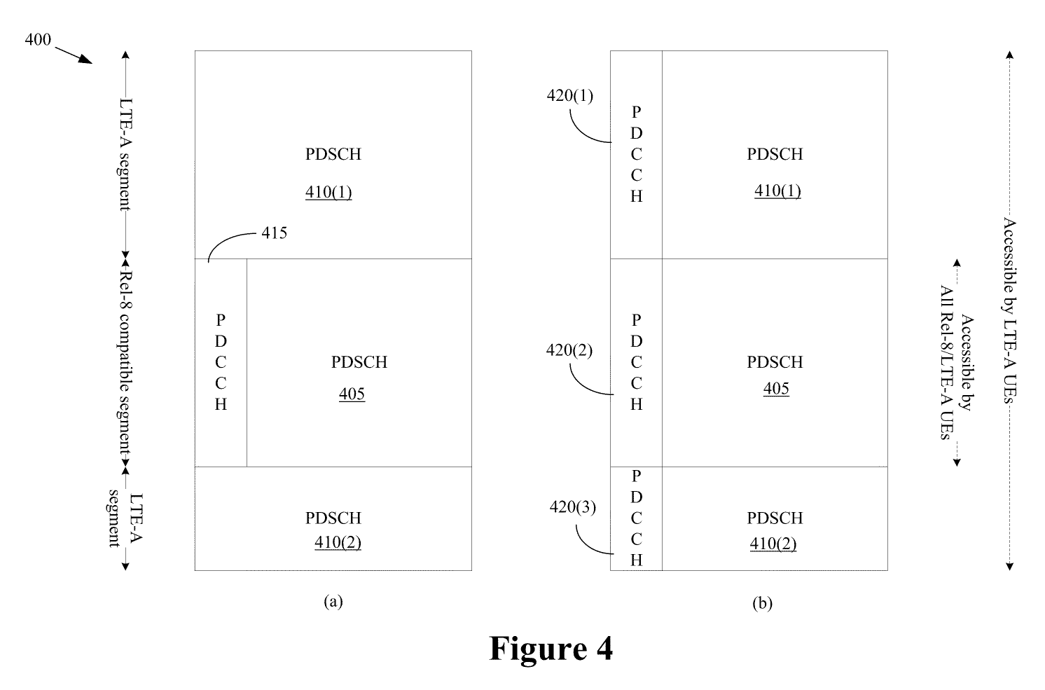

FIGS. 4(a) and 4(b) conceptually illustrate fourth and fifth exemplary embodiments of a component carrier structure 400 formed by aggregating a backward-compatible component carrier 405 and one or more non-backwards-compatible component carriers 410(1-2). The component carrier structure 400 is depicted in frequency-time space with the frequency of the allocated bandwidth increasing from bottom to top of the figure and with the allocated time interval increasing from left to right in the figure. Units of frequency and time are arbitrary. In the fourth and fifth exemplary embodiments, the backward-compatible component carrier 405 is compatible with Release 8 of LTE and the non-backward compatible component carriers 410 operate according to a subsequent release such as LTE-Advanced. However, persons of ordinary skill in the art having benefit of the present disclosure should appreciate that other embodiments may utilize other standards and/or protocols, as well as different releases thereof.

The fourth and fifth exemplary embodiment differs from the first and second exemplary embodiments shown in FIG. 2 because the backward-compatible component carrier 405 and the non-backward-compatible component carriers 410 are contiguous in frequency and are not separated by gaps or guard bands in frequency. The bandwidth allocated to the carriers 405, 410 may differ in various embodiments. In the illustrated embodiment, the non-backwards compatible component carrier 410(1) has a larger bandwidth than the backward-compatible component carrier 405, while the non-backward-compatible component carrier 410(2) has a smaller bandwidth than the backward-compatible component carrier 405. However, persons of ordinary skill in the art having benefit of the present disclosure should appreciate that the particular bandwidth allocations depicted in FIGS. 4(a) and 4(b) are intended to be illustrative and not to limit the claimed subject matter.

The component carriers 405, 410 support physical downlink control channels 415, 420 that are used to carry control information for the component carriers 405, 410. Exemplary control information carried by the PDCCH 415 may include synchronization signals, paging information, pilot signals, access information, and the like. The backward-compatible component carrier 405 and the non-backwards compatible component carriers 410 can therefore be scheduled independently or as an aggregated component carrier, as will be discussed herein. For example, Rel-8 UE operation is allowed in Rel-8 compatible carriers 405 and operation of UEs that support LTE-A is allowed in the Rel-8 compatible carrier 405 and/or the LTE-A carriers 410. For LTE-A UE, the physical downlink shared channel (PDSCH) may be transmitted in one or multiple carriers in a subframe. A carrier indicator field (CIF) in a new downlink control information (DCI) format for the downlink allocation indicates the component carrier for PDSCH transmission.

In the fourth exemplary embodiment shown in FIG. 4(a), control channels for both the backwards compatible component carrier 405 and the non-backwards compatible component carriers 410 are carried by channels in the backward-compatible component carrier 405. For example, resources of the backwards compatible carrier 405 can be allocated to a physical downlink control channel (PDCCH) 415 that can be configured to carry control information for both the backwards compatible carrier 205 and the non-backward-compatible carriers 410. Each UE therefore monitors three PDCCHs 415 in the backwards compatible carrier 405 to determine the DL allocation.

In the fifth exemplary embodiment shown in FIG. 4(b), the backwards compatible component carrier 405 and the non-backwards compatible component carriers 410 each carry their respective control channels. For example, resources of the backwards compatible carrier 405 can be allocated to a physical downlink control channel (PDCCH) 420(2) that can be configured to carry control information for the backwards compatible carrier 405. Resources of the non-backwards compatible carriers 410 can be allocated to physical downlink control channels (PDCCH) 420(1, 3) that can be configured to carry control information for the non-backward-compatible carriers 410. When the component carriers 405, 410 are aggregated, each UE monitors the PDCCHs 420 in the three component carriers 405, 410 to determine the DL allocation.

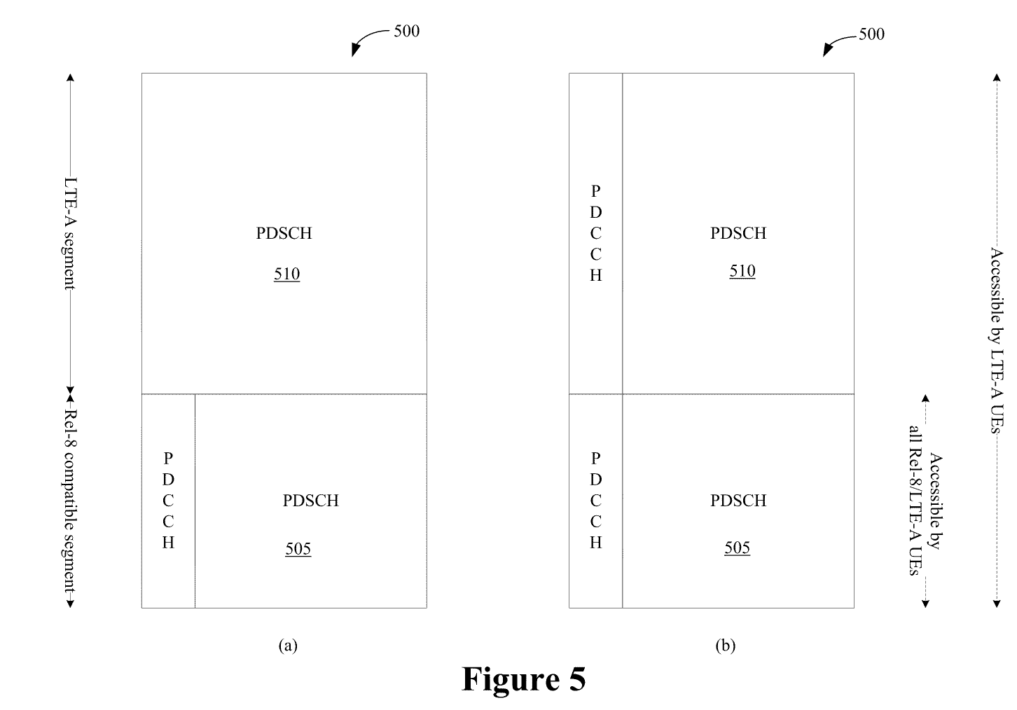

FIGS. 5(a) and 5(b) conceptually illustrate sixth and seventh exemplary embodiments of a component carrier structure 500 formed by aggregating a backward-compatible component carrier 505 and a non-backwards-compatible component carriers 510. The component carrier structure 400 is depicted in frequency-time space with the frequency of the allocated bandwidth increasing from bottom to top of the figure and with the allocated time interval increasing from left to right in the figure. Units of frequency and time are arbitrary. The sixth and seventh exemplary embodiments of the component carrier structure 500 operate in a similar fashion to the other exemplary embodiments discussed herein. However, the sixth and seventh exemplary embodiments differ from the fourth and fifth exemplary embodiments because the non-backwards compatible component carriers 510 are distributed asymmetrically about the backwards compatible component carrier 505 in frequency space.

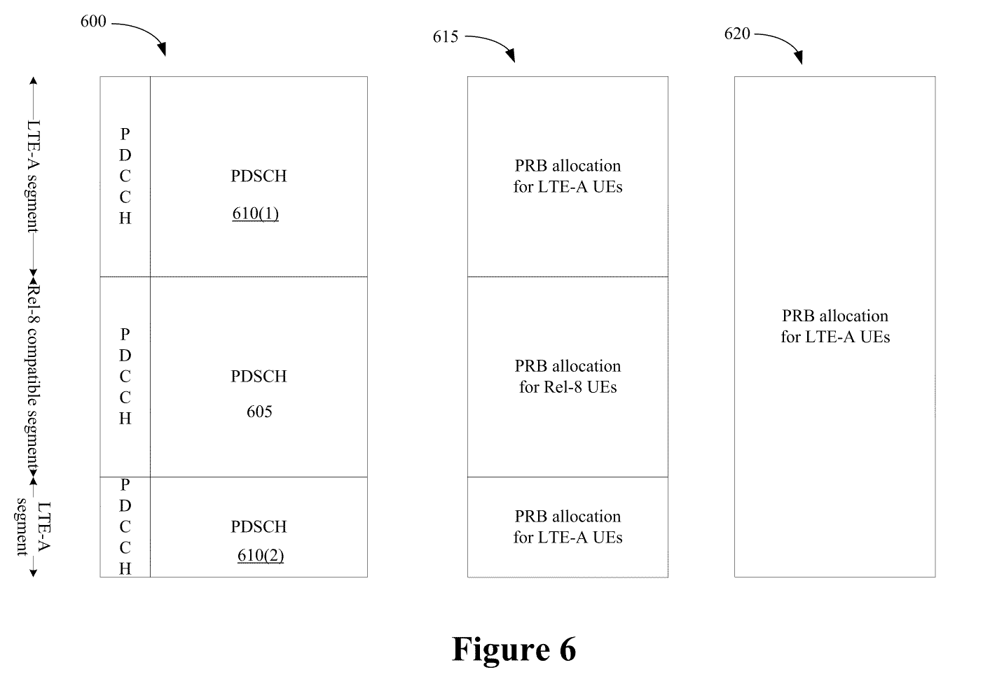

FIG. 6 conceptually illustrates scheduling of physical resource blocks (PRB) for an aggregated component carrier structure 600. In the illustrated embodiment, the backward-compatible component carrier 605 and the non-backward-compatible component carriers at 610(1-2) are contiguous and each support their own control channels (PDCCH). However, persons of ordinary skill in the art having benefit of the present disclosure should appreciate that the scheduling techniques described with regard to FIG. 6 may also be used to schedule other aggregations of component carriers, including the various embodiments of component carrier structures described herein. Exemplary allocations 615, 620 are depicted for two different scheduling intervals. In operation, the scheduling intervals may be used in any order and the order may be determined by a scheduler or other entities within the network using criterion including the number of active LTE-A and LTE user equipment, the distribution of the user equipment, channel qualities associated with the user equipment, and the like.

In the first scheduling interval, the backward-compatible component carrier 605 and the non-backwards compatible component carriers 610 are scheduled independently. Scheduling may be performed by a single scheduler that separately schedules the carriers 605, 610 or it may be performed by separate schedulers assigned to the carriers 605, 610. The scheduler may be implemented in a base station or other network entity. Physical resource blocks of the non-backwards compatible component carriers 610 are scheduled/allocated to the LTE-A user equipment and physical resource blocks of the backward-compatible component carrier 605 are scheduled/allocated to the Release 8 LTE user equipment. In the second scheduling interval, the component carriers 605, 610 are aggregated so that a single scheduler can schedule the entire aggregated spectrum/bandwidth to user equipment that are compatible with the non-backwards compatible component carriers 610. Physical resource blocks of the aggregated component carriers 605, 610 are scheduled/allocated to the LTE-A user equipment.

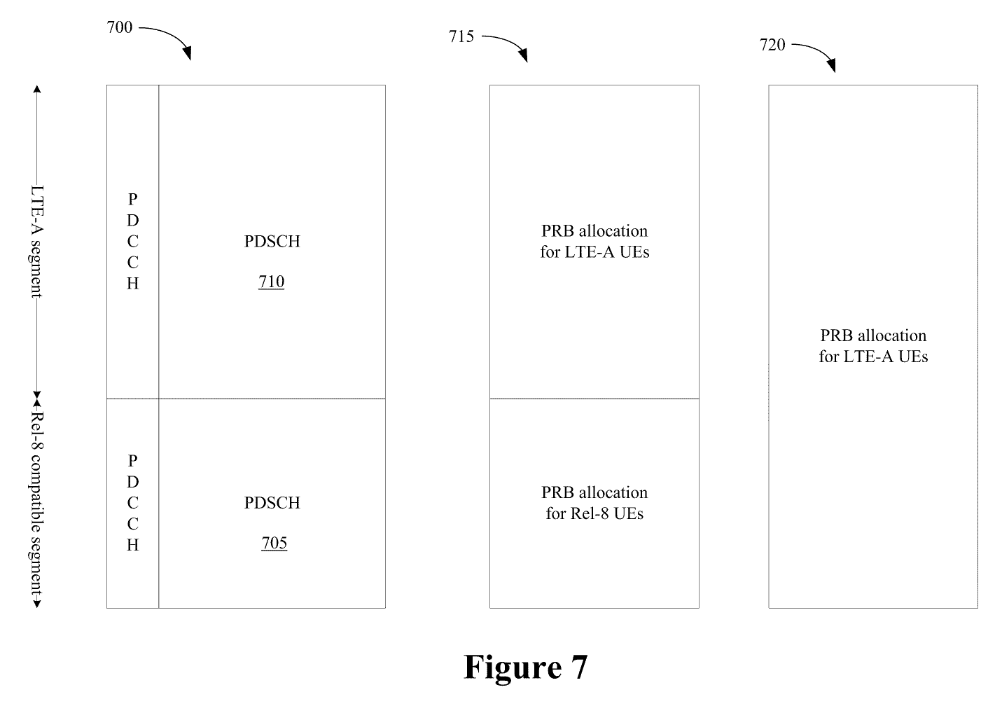

FIG. 7 conceptually illustrates scheduling of physical resource blocks (PRB) for an asymmetric aggregated component carrier structure 700. In the illustrated embodiment, the backward-compatible component carrier 705 and the non-backward-compatible component carrier 710 are contiguous and each support their own control channels (PDCCH). However, persons of ordinary skill in the art having benefit of the present disclosure should appreciate that the scheduling techniques described with regard to FIG. 7 may also be used to schedule other asymmetric aggregations of component carriers, including the various embodiments of component carrier structures described herein. Exemplary allocations 715, 720 are depicted for two different scheduling intervals. In operation, the scheduling intervals may be used in any order and the order may be determined by a scheduler or other entities within the network using criterion including the number of active LTE-A and LTE user equipment, the distribution of the user equipment, channel qualities associated with the user equipment, and the like.

In the first scheduling interval 715, the backward-compatible component carrier 705 and the non-backwards compatible component carrier 710 are scheduled independently. Physical resource blocks of the non-backwards compatible component carrier 710 are scheduled/allocated to the LTE-A user equipment and physical resource blocks of the backward-compatible component carrier 705 are scheduled/allocated to the Release 8 LTE user equipment. In the second scheduling interval 720, the component carriers 705, 710 are aggregated so that a single scheduler can schedule the entire aggregated spectrum/bandwidth to user equipment that are compatible with the non-backwards compatible component carrier 710. Physical resource blocks of the aggregated component carriers 705, 710 are scheduled/allocated to the LTE-A user equipment in the second scheduling interval.

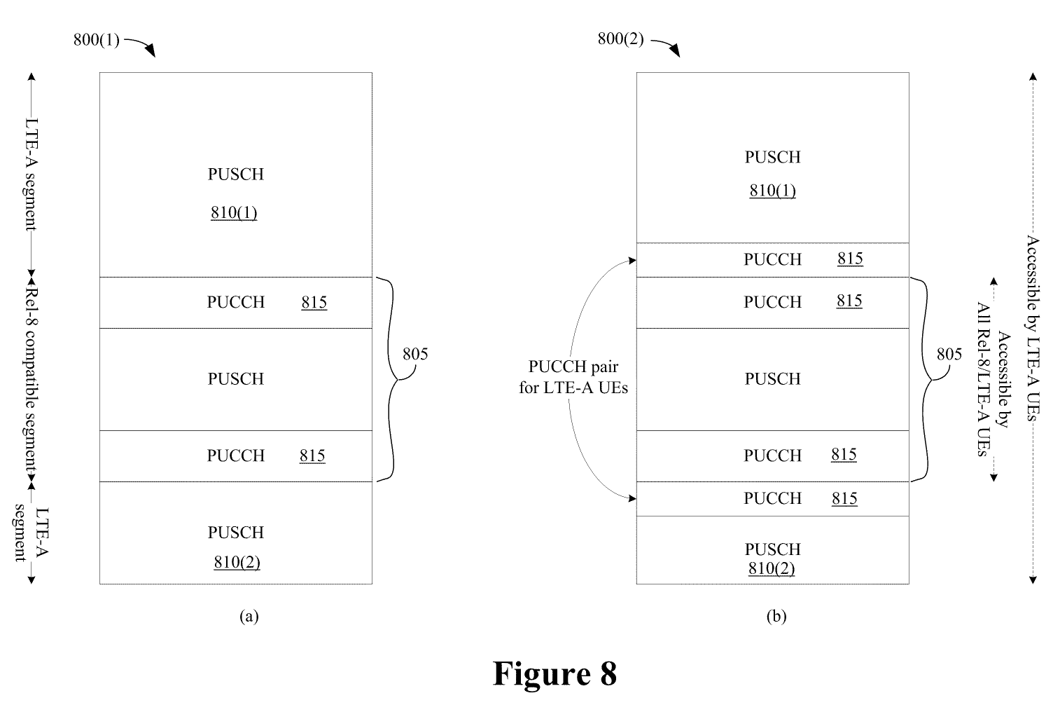

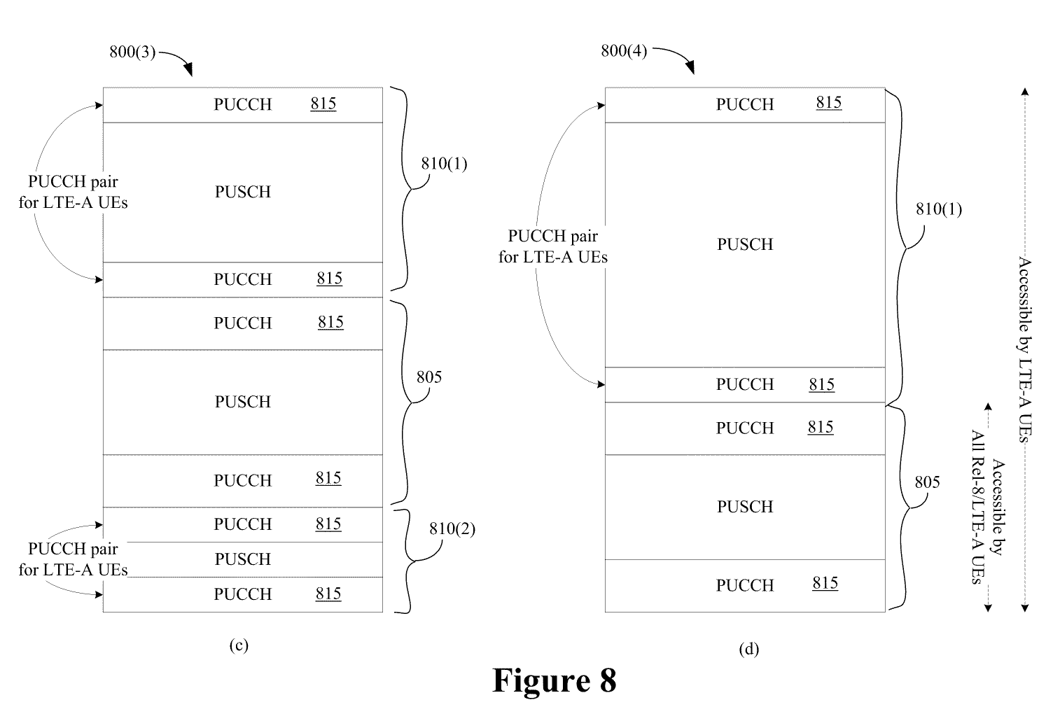

FIGS. 8(a-d) conceptually illustrate exemplary embodiments of a component carrier structure 800 formed by aggregating a backward-compatible component carrier 805 and one or more non-backwards-compatible component carriers 810(1-2). The component carrier structure 800 is depicted in frequency-time space with the frequency of the allocated bandwidth increasing from bottom to top of the figure and with the allocated time interval increasing from left to right in the figure. Units of frequency and time are arbitrary. The illustrated component carrier structure 800 can be used for uplink (reverse link) communication. In the first and second exemplary embodiments, the backward-compatible component carrier 805 is compatible with Release 8 of LTE and the non-backward compatible component carriers 810 operate according to a subsequent release such as LTE-Advanced. However, persons of ordinary skill in the art having benefit of the present disclosure should appreciate that other embodiments may utilize other standards and/or protocols, as well as different releases thereof. Scheduling for the aggregated uplink component carriers 800 can be performed as described herein for aggregated downlink component carriers.

The embodiment depicted in FIG. 8(a) uses LTE-A non-backward-compatible component carriers 810 that do not include signaling channels within their allocated bandwidth. Control signaling for the component carriers 810 is provided within the physical uplink control channels (PUCCHs) 815 that are implemented within the allocated bandwidth of the backward-compatible component carrier 805. This option allows additional capacity for a physical uplink shared channel (PUSCH) within the non-backward-compatible component carriers 810 by keeping the PUCCH 815 in the backward-compatible component carrier 805. For example, the PUCCH 820 for all user equipment (e.g., user equipment that operate according to LTE-A and user equipment that operate according to Rel-8) can be mapped to channels in the backward-compatible component carrier 805. This option could be useful to support increased PUSCH traffic per user, while reusing PUCCH configuration from previous releases.

The embodiment depicted in FIG. 8(b) shows an alternate configuration of the control channels in which the PUCCHs 820 are implemented within the bandwidth of the respective component carriers 805, 810. In the illustrated embodiment, the PUCCHs 820 for the non-backwards compatible component carriers 810 are allocated to interior bands of the bandwidth allocated to the non-backwards compatible component carriers 810. The PUCCHs 820 for the two types of component carriers 805, 810 are therefore adjacent in frequency space. This option allows flexibility in PUSCH allocation in the non-backwards compatible component carriers 810. For example, to avoid interference issues at the edges of the spectrum, the number of PRBs and/or the power for the PUSCH in the LTE-A component carrier 810 can be controlled by scheduler design and power control at the corresponding base station or e-node B (eNB). This option may also be available when LTE-A segments are available in pairs.

The embodiments depicted in FIG. 8(c-d) show another configuration of the control channels in which the PUCCHs 815 are implemented in pairs within the bandwidth of the respective component carriers 805, 810. Each pair of PUCCHs 820 can be allocated to frequencies near the edge of the bandwidth of the backward and non-backward-compatible component carriers 805, 810. This option introduces PUCCH resources in each non-backwards compatible component carrier 805, which can be used to support asymmetric addition of component carriers, as depicted in FIG. 8(d).

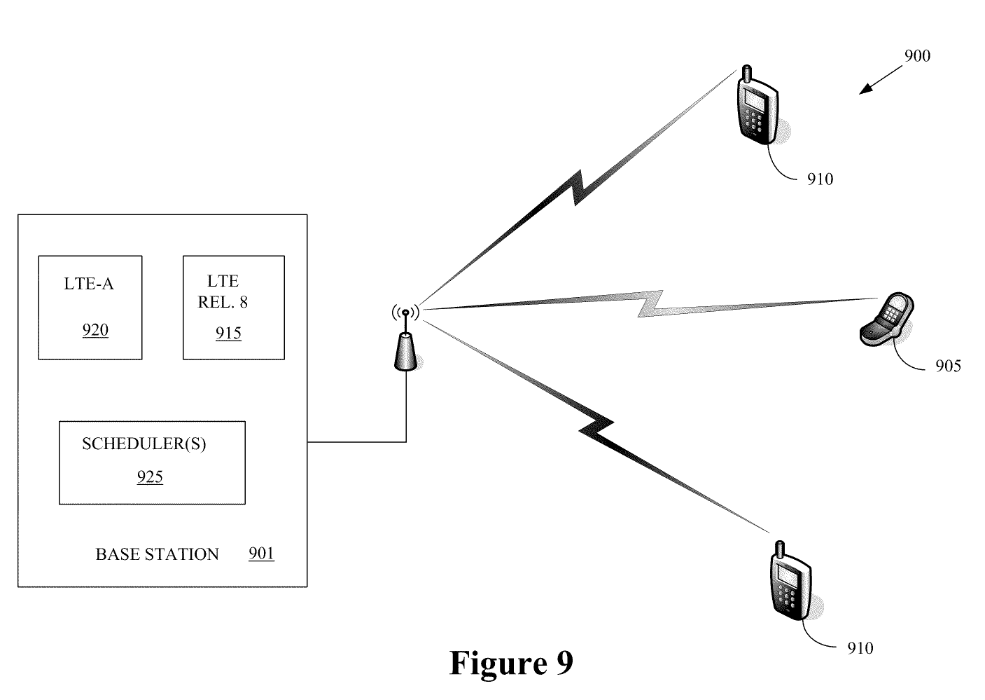

FIG. 9 conceptually illustrates one exemplary embodiment of a wireless communication system 900 that can implement embodiments of the carrier aggregation technique described herein. In the illustrated embodiment, a base station 901 supports wireless communication with user equipment 905 that operate according to a previous or legacy release of a wireless communication standard and user equipment 910 that operate according to a current or most recent release of the wireless communication standard. For example, user equipment 905 may operate according to Release 8 of LTE and user equipment 910 may operate according to LTE-Advanced. Although a single base station 901 is depicted in FIG. 9, persons of ordinary skill in the art having benefit of the present disclosure should appreciate that other embodiments of the wireless communication system 900 may implement larger numbers of base stations.

The base station 901 includes modules for supporting wireless communication with user equipment 905, 910. In the illustrated embodiment, the base station 901 includes a module 915 that is used to support Release 8 of LTE and a module 920 that is used to support LTE-Advanced. The modules 915, 920 implement functionality that is used to communicate over the air interface using backward-compatible component carriers (e.g., module 915) and non-backwards component carriers (e.g., module 920). The modules 915, 920 may be implemented in hardware, software, firmware, or any combination thereof. The base station 901 also includes one or more schedulers 925 that are used to schedule uplink and/or downlink communication between the base station 901 and user equipment 905, 910, as discussed herein. For example, the scheduler 925 may concurrently schedule user equipment 905 to the backwards compatible component carriers and user equipment 910 to the non-backwards compatible component carriers for one or more time intervals. Another time intervals, the scheduler 925 can allocate the aggregated spectrum of the backward-compatible component carriers and the non-backwards compatible component carriers to user equipment 920. The scheduler 925 can also be configured to allocate data transmission and/or power to the physical resource blocks that are within the available spectrum bandwidth and that meet the channel interference requirements for adjacent cells. For example, the scheduler 925 can be configured to allocate physical resource blocks within non-contiguous, contiguous, and/or overlapping component carriers, subject to any channel interference requirements and/or mitigation schemes implemented in the wireless communication system.

Embodiments of the techniques and systems described herein may have a number of advantages over conventional practice and other proposed bandwidth extension techniques. For example, orthogonal access systems that implement embodiments of the carrier aggregation technique described herein may be able to support asymmetric carrier extension by aggregation of multiple contiguous spectrum blocks for both uplink and downlink bands. Moreover, control channels for the aggregated component carriers can be flexibly configured, which may permit numerous and flexible deployment options depending on factors such as the quality of the operator's spectrum. For example, allocation and control of LTE physical resource blocks (PRB) may be controlled and/or modified to reduce the impact of adjacent band interference or to reduce the interference to neighbor bands. The physical resource blocks may also be allocated to support interference coordination efforts, e.g., between neighboring cells. The control channel using the systems can be PDCCH for the downlink of LTE system and PUCCH for the uplink of LTE system, as well as other control signaling channels and/or overhead channels. The PDCCH may include channels such as the Physical Control Format Indicator Channel (PCFICH) that is used to indicate the number of control channel symbols and the Physical Hybrid Automatic Repeat Request Indicator Channel (PHICH) that is used for transmission of downlink ACK/NAK signals in the LTE system.

Embodiments of the techniques and systems described herein may have additional advantages when deployed in systems that support contiguous component carriers. For example, embodiments of the techniques described herein support introduction of guard band-less multi-carrier deployment option for contiguous spectrum. Moreover, these techniques can reduce or minimize the overhead channel for contiguous carrier aggregation by not transmitting overhead channels in the LTE-A compatible segments

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method, comprising:
aggregating, at a base station, at least one first component carrier that is backwards compatible with a first carrier type and at least one second component carrier that is non-backwards compatible with the first carrier type for communication with first user equipment according to a second carrier type used by said at least one second component carrier.

2. The method of claim 1, wherein aggregating said at least one first component carrier and said at least one second component carrier comprises scheduling said first user equipment to physical resource blocks within said at least one second component carrier for communication according to the second carrier type and scheduling second user equipment to physical resource blocks within said at least one first component carrier for communication according to the first carrier type.

3. The method of claim 1, wherein aggregating said at least one first component carrier and said at least one second component carrier comprises scheduling said user equipment to physical resource blocks within an aggregated spectrum comprising a first frequency range assigned to said at least one first component carrier and a second frequency range assigned to said at least one second component carrier.

4. The method of claim 2, wherein said at least one first component carrier comprises at least one first downlink component carrier and said at least one second component carrier comprises at least one second downlink component carrier, and comprising transmitting information from the base station in the scheduled physical resource blocks.

5. The method of claim 4, comprising providing downlink control information for the aggregated first and second component carriers only in said at least one first downlink component carrier.

6. The method of claim 4, comprising providing downlink control information for the aggregated first and second component carriers in said at least one first downlink component carrier and said at least one second downlink component carrier.

7. The method of claims 2, wherein said at least one first component carrier comprises at least one first uplink component carrier and said at least one second component carrier comprises at least one second uplink component carrier, and comprising receiving information at the base station in the scheduled physical resource blocks.

8. The method of claim 7, comprising receiving uplink control information for the aggregated first and second component carriers only in said at least one first uplink component carrier.

9. The method of claim 7, comprising receiving uplink control information for the aggregated first and second component carriers in said at least one first uplink component carrier and said at least one second uplink component carrier.

10. The method of claim 1, wherein aggregating said at least one first component carrier and said at least one second component carrier comprises asymmetrically aggregating said at least one second component carrier with respect to said at least one first component carrier.

11. The method of claim 1 wherein aggregating said at least one first component carrier and said at least one second component carrier comprises aggregating said at least one first component carrier that is contiguous with said at least one second component carrier.

12. The method of claim 1 wherein aggregating said at least one first component carrier and said at least one second component carrier comprises aggregating said at least one first component carrier that is noncontiguous with said at least one second component carrier.

13. A method, comprising:
scheduling, at a base station, first user equipment to at least one first component carrier that is backwards compatible with a first carrier type for communication according to the first carrier type and second user equipment to at least one second component carrier that is non-backwards compatible with the first carrier type during a first time interval; and
scheduling said second user equipment to said at least one first component carrier and said at least one second component carrier during a second time interval.

14. The method of claim 13, wherein scheduling said second user equipment during the second time interval comprises scheduling said second user equipment to physical resource blocks within an aggregated spectrum comprising a first frequency range assigned to said at least one first component carrier and a second frequency range assigned to said at least one second component carrier.

15. The method of claim 13, comprising providing control information for the first and second component carriers only in said at least one first component carrier.

16. The method of claim 15, wherein scheduling said first and second user equipment comprises scheduling at least one of said first and second user equipment to overlapping first and second component carriers.

17. The method of claim 15, comprising turning off said at least one second component carrier during at least one of the first and second time intervals when a cell loading is below a selected threshold.

18. The method of claim 13, comprising providing control information for the first and second component carriers in said at least one first component carrier and said at least one second component carrier.

19. The method of claim 13, wherein scheduling said at least one first component carrier and said at least one second component carrier during the second time interval comprises asymmetrically aggregating said at least one second component carrier with respect to said at least one first component carrier.

20. A method, comprising:
performing, at first user equipment, scheduled communication with a base station over at least one first component carrier that is backwards compatible with a first carrier type and at least one second component carrier that is non-backwards compatible with the first carrier type during a first time interval; and
performing, at the first user equipment, scheduled communication with the base station over said at least one second component carrier during a second time interval concurrently with second user equipment performing scheduled communication with the base station over said at least one first component carrier, wherein the second user equipment is incompatible with a second carrier type of said at least one second component carrier.

21. The method of claim 20, wherein performing scheduled communication during the first time interval comprises communicating using physical resource blocks that are scheduled within an aggregated spectrum comprising a first frequency range assigned to said at least one first component carrier and a second frequency range assigned to said at least one second component carrier.

22. The method of claim 20, comprising providing control information for the first and second component carriers only in said at least one first component carrier.

23. The method of claim 20, comprising providing control information for the first and second component carriers in said at least one first component carrier and said at least one second component carrier.

24. The method of claim 20, wherein performing scheduled communication using said at least one first component carrier and said at least one second component carrier during the first time interval comprises performing scheduled communication using an asymmetric aggregation of said at least one second component carrier with respect to said at least one first component carrier.
